(19) United States
(12) Patent Application Publication
(10) Pub. No.: US 2014/0297173 A1
(43) Pub. Date: Oct. 2, 2014

(54) System for alerting automobile driver when opening door

(71) Applicant: Ming-Chih Li, Changhua (TW)

(72) Inventor: Ming-Chih Li, Changhua (TW)

(21) Appl. No.: 14/307,495

(22) Filed: Jun. 18, 2014

(51) Int. Cl. B60Q 1/00; B60Q 5/00; G08G 1/056

(52) U.S. Cl. CPC B60Q 1/0023; G08G 1/056; B60Q 5/006
USPC 701/301

(57) ABSTRACT

An alert system for an automobile is provided with in combination a buzzer; a lamp; two sensors each disposed in a vehicle door of either side of the automobile; two activation devices each disposed in the vehicle door of either side of the automobile and operatively connected to an inner door handle; and a controller electrically connected to the activation devices, the buzzer, the lamp, the sensors, indicator lights, and a horn. After parking the automobile, one sensor sensing a vehicle coming from behind and one side, and a vehicle door being opened by pulling the inner door handle, the activation device is activated by the inner door, a signal is generated by the activation device, and the signal is sent to the controller which instructs the buzzer to make a buzzing sound, the lamp to light, the indicator lights to flash, and the horn to sound an alarm.

### BACKGROUND OF THE INVENTION

1. Field of the Invention

The invention relates to motor vehicle safety devices and more particularly to a system for visually and audibly alerting an automobile driver of a motor vehicle from behind and one side when opening a vehicle door.

2. Description of Related Art

Driver and/or occupant(s) of a car may pay attention to a motor vehicle from behind and one side when opening a vehicle door. This is because the vehicle coming from behind and one side may hit the open door to cause accident.

However, there are no disclosures of devices for alerting an automobile driver of a motor vehicle from behind and one side when opening a vehicle door as the present inventor is aware. Thus, the need for such device exists.

### SUMMARY OF THE INVENTION

It is therefore one object of the invention to provide a n alert system for an automobile, comprising in combination a buzzer; a lamp; two sensors each disposed in a vehicle door of either side of the automobile; two activation devices each disposed in the vehicle door of either side of the automobile and operatively connected to an inner door handle; and a controller electrically connected to the activation devices, the buzzer, the lamp, the sensors, a plurality of indicator lights of the automobile, and a horn of the automobile; wherein in response to parking the automobile and one of the sensors sensing a motor vehicle coming from behind and one side of the automobile, a signal is generated by one of the sensors and sent to the controller, the controller instructs the indicator lights to flash, and the horn to sound an alarm; and wherein in response to parking the automobile, one of the sensors sensing a motor vehicle coming from behind and one side of the automobile, and a vehicle door of the automobile being opened by pulling the inner door handle, the activation device is activated by the inner door, a second signal is generated by the activation device, the second signal is sent to the controller, and the controller instructs the buzzer to make a buzzing sound, the lamp to light, the indicator lights to flash, and the horn to sound an alarm.

The above and other objects, features and advantages of the invention will become apparent from the following detailed description taken with the accompanying drawings.

### BRIEF DESCRIPTION OF THE DRAWINGS

FIG. 1 is an exploded view of a system for alerting an automobile driver of a vehicle from behind and one side when opening a door according to a first preferred embodiment of the invention;

FIG. 2 is a perspective view of the activation device, the buzzer, and the LED lamp mounted in a vehicle door;

FIG. 3 is a view similar to FIG. 2 showing the activation device, the buzzer, and the LED lamp being activated;

FIGS. 4 to 7 are views showing sensing of a motor vehicle coming from behind and one side;

FIGS. 8 and 9 are views showing inactivation of the alert system;

FIG. 10 is an exploded view of a system for alerting an automobile driver of a vehicle from behind and one side when opening a door according to a second preferred embodiment of the invention; and

FIG. 11 is a view similar to FIG. 10 showing the components being activated.

### DETAILED DESCRIPTION OF THE INVENTION

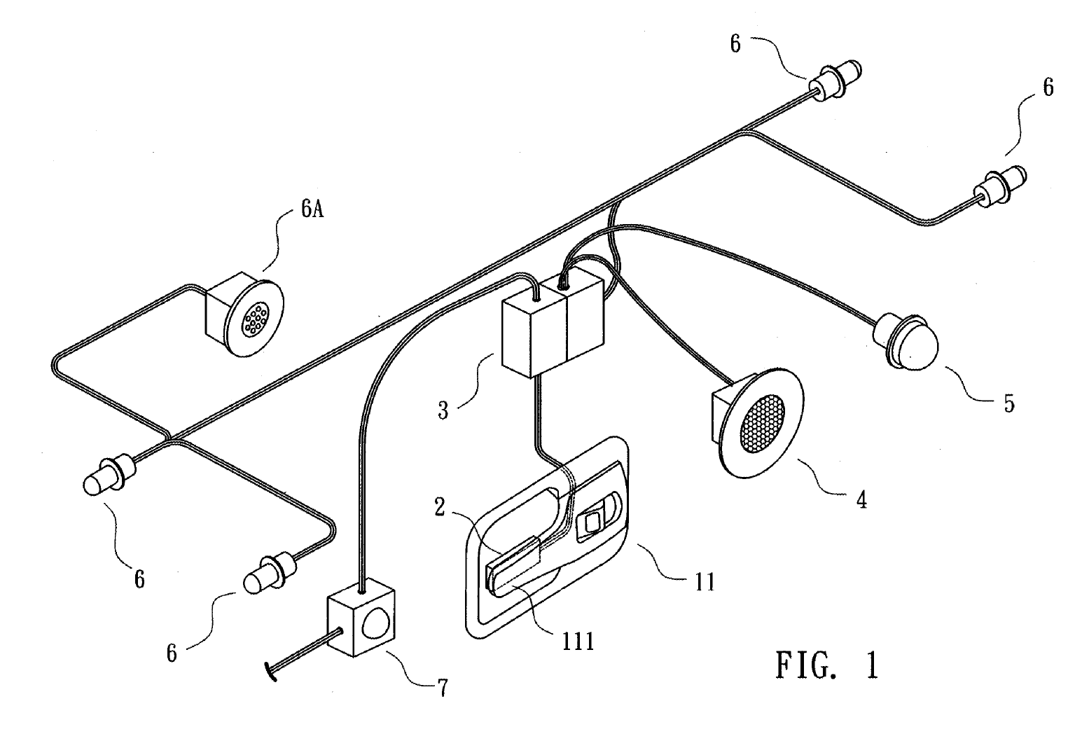

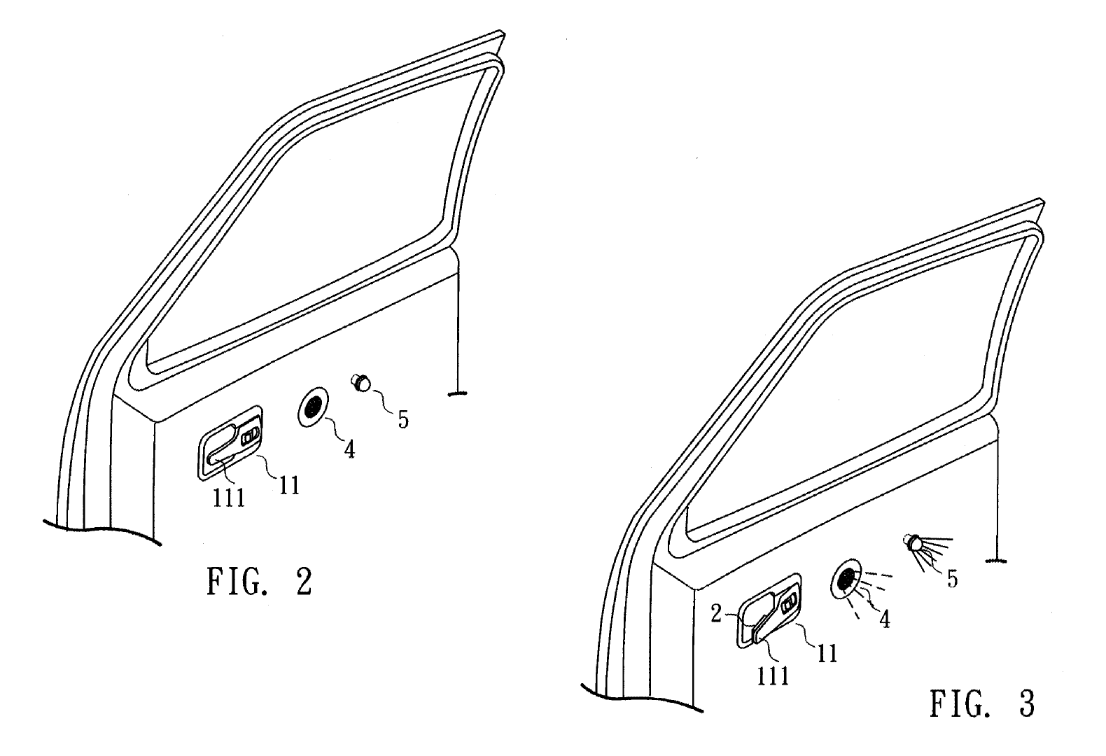

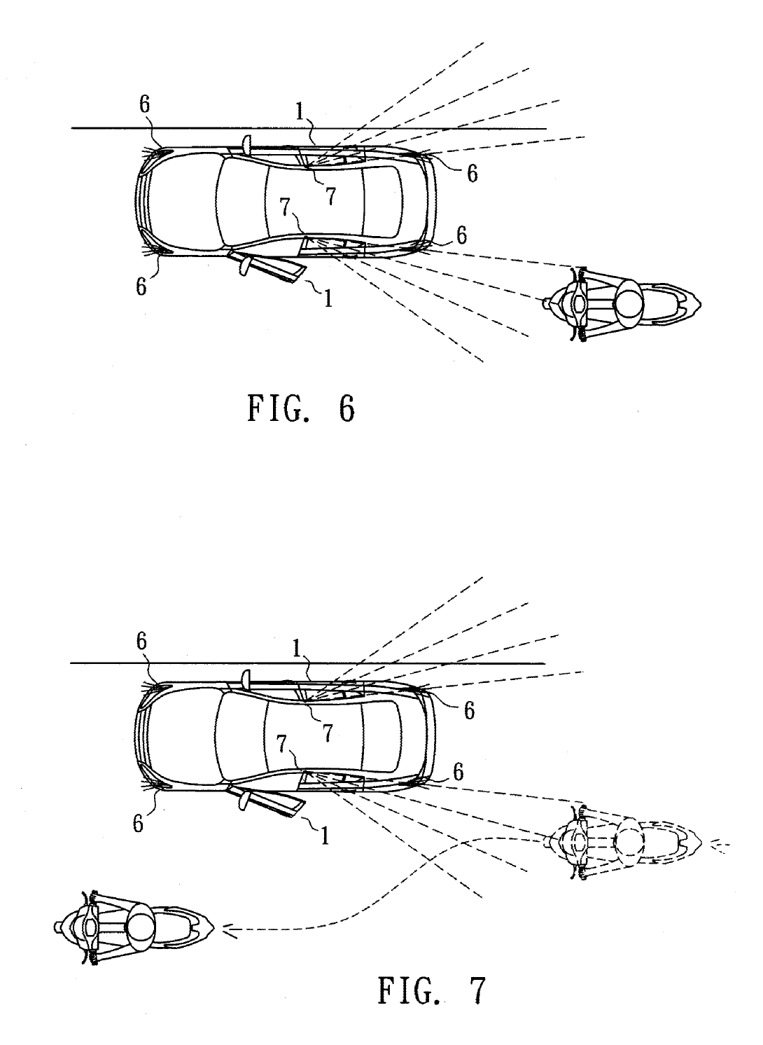

Referring to FIGS. 1 to 9, a system for alerting an automobile driver of a motor vehicle from behind and one side when opening a vehicle door in accordance with a first preferred embodiment of the invention is shown and comprises the following components as discussed in detail below.

Two sensors 7 each are provided in a vehicle door of either side for sensing a motor vehicle (e.g., a running motor cycle) from behind and one side. An activation device 2 is provided in each vehicle door and is configured to be activated by a hinged end 111 of an inner door handle 11. A controller 3 is electrically connected to the activation device 2. A buzzer 4 and an LED (light-emitting diode) lamp 5 are electrically connected to the controller 3 which is also electrically connected to indicator lights 6 and a horn 6A of the automobile.

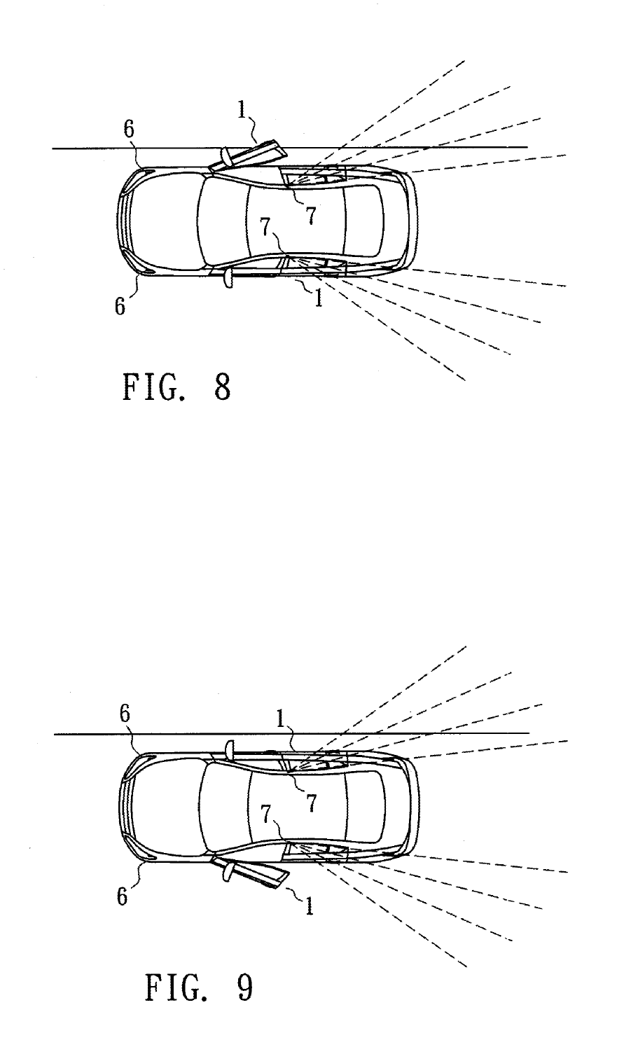

The alert system is inactivated when there is no vehicle from behind and one side and either side sensed by the sensor 7 (see FIGS. 8 and 9).

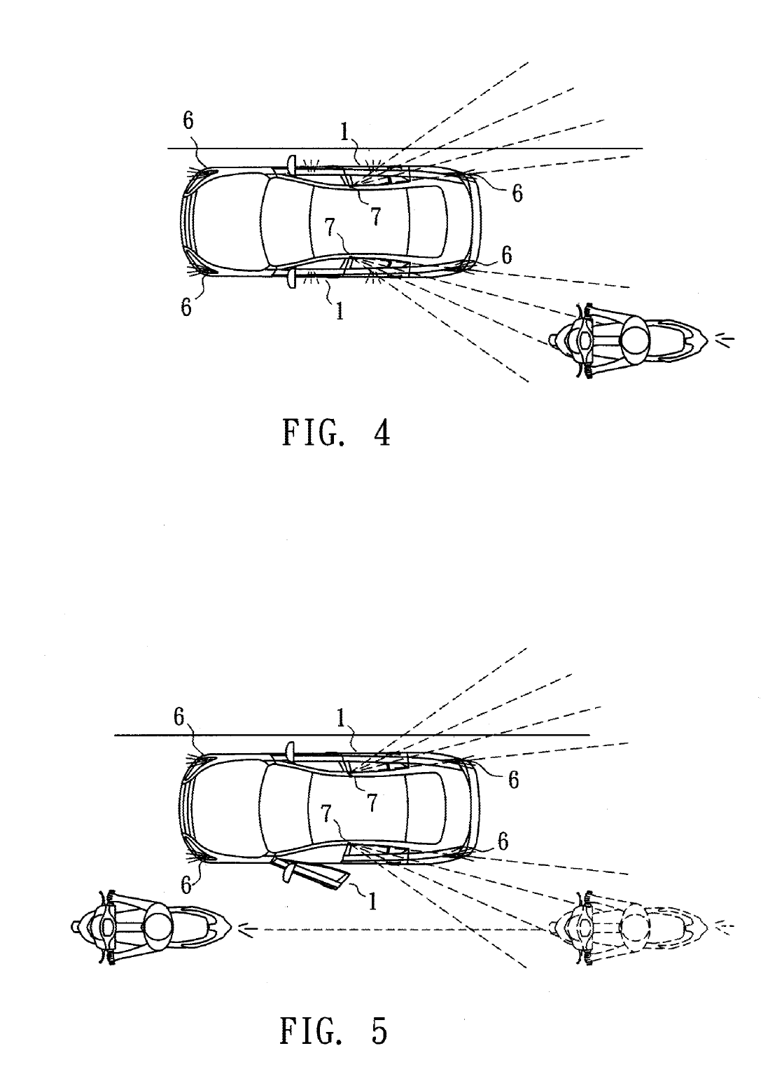

As shown in FIGS. 4 to 7, after parking an automobile and the sensor 7 sensing a motor vehicle (e.g., a motorcycle) coming from behind and one side of the automobile when the motor vehicle comes into the sensor's 7 sensing range, a signal is generated by the sensor 7 and sent to the controller 3. And in turn, the controller 3 instructs the indicator lights 6 to flash for about 3-5 seconds, and the horn 6A to sound an alarm for about 3-5 second as a means of alerting a driver and any passengers in the automobile. It is understood that the activation of the activation device 2 may take several seconds due to time delay effect.

As shown in FIGS. 4 to 7, alternatively, after parking an automobile, the sensor 7 sensing a motor vehicle (e.g., a motorcycle) coming from behind and one side of the automobile when the motor vehicle comes into the sensor's 7 sensing range, and at the same time the driver or any passenger opening the vehicle door by pulling the inner door handle 11 due to unawareness of the motor vehicle, the activation device 2 is activated by the hinged end 111 and a second signal is generated by the activation device 2. The second signal is sent to the controller 3. And in turn, the controller 3 instructs the buzzer 4 to make a buzzing sound, the LED lamp 5 to light, the indicator lights 6 to flash for about 3-5 seconds, and the horn 6A to sound an alarm for about 3-5 second as a means of alerting the driver and any passenger in the automobile. It is understood that the activation of the activation device 2 may take several seconds due to time delay effect.

The controller 3 can be set to adjust the LED lamp 5 and/or the buzzer 4.

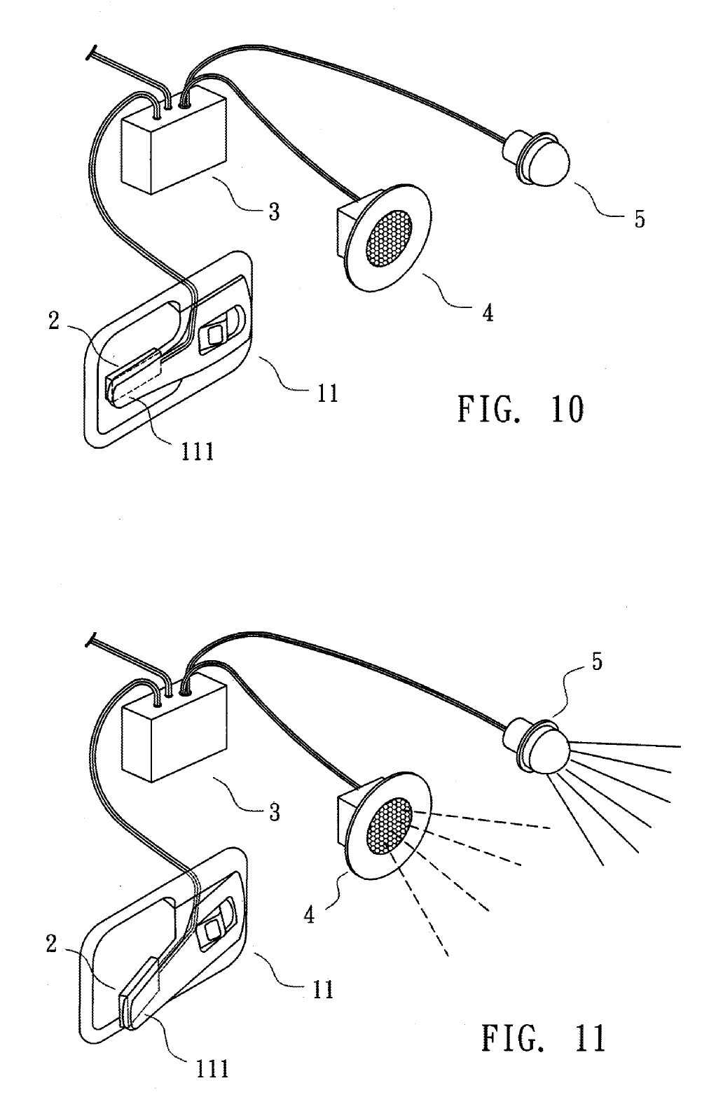

Referring to FIGS. 10 and 11, a system for alerting an automobile driver of a motor vehicle from behind and one side when opening a vehicle door accordance with a second preferred embodiment of the invention is shown. The characteristics of the second preferred embodiment are substantially the same as that of the first preferred embodiment except the following: The sensors 7 are eliminated.

While the invention has been described in terms of preferred embodiments, those skilled in the art will recognize that the invention can be practiced with modifications within the spirit and scope of the appended claims.

What is claimed is:

1. An alert system for an automobile, comprising in combination:
a buzzer;
a lamp;
two sensors each disposed in a vehicle door of either side of the automobile;
two activation devices each disposed in the vehicle door of either side of the automobile and operatively connected to an inner door handle; and
a controller electrically connected to the activation devices, the buzzer, the lamp, the sensors, a plurality of indicator lights of the automobile, and a horn of the automobile;
wherein in response to parking the automobile and one of the sensors sensing a motor vehicle coming from behind and one side of the automobile, a signal is generated by one of the sensors and sent to the controller, the controller instructs the indicator lights to flash, and the horn to sound an alarm; and
wherein in response to parking the automobile, one of the sensors sensing a motor vehicle coming from behind and one side of the automobile, and a vehicle door of the automobile being opened by pulling the inner door handle, the activation device is activated by the inner door, a second signal is generated by the activation device, the second signal is sent to the controller, and the controller instructs the buzzer to make a buzzing sound, the lamp to light, the indicator lights to flash, and the horn to sound an alarm.
